(19) United States
(12) Patent Application Publication
(10) Pub. No.: US 2016/0227323 A1
(43) Pub. Date: Aug. 4, 2016

(54) Receiver Having Diaphragm with Improved Rigidity

(71) Applicant: EM-TECH. Co., Ltd., Busan (KR)

(72) Inventors: Jong Soo Yoon, Gyeongsangnam-do (KR); Jae Hwa Lim, Gyeongsangnam-do (KR)

(21) Appl. No.: 15/009,553

(22) Filed: Jan. 28, 2016

(30) Foreign Application Priority Data
Jan. 30, 2015 (KR) 10-2015-0014938

(51) Int. Cl. H04R 7/16; H04R 7/14; H04R 7/12; H04R 9/06; H04R 9/02

(52) U.S. Cl. CPC H04R 7/16; H04R 9/06; H04R 9/025; H04R 7/122; H04R 7/14; H04R 2499/11

(57) ABSTRACT

A receiver having a diaphragm with improved rigidity includes a frame, a yoke coupled to the frame and forming a bottom surface, a magnet coupled to the yoke, a voice coil having a lower end positioned in an air gap of the magnet, and configured to vibrate up and down by mutual electromagnetic force as a current is applied to the voice coil, a side diaphragm configured to allow the voice coil to be attached to a lower surface of the side diaphragm, a central diaphragm attached to the center of the side diaphragm, and a protector coupled to the frame to cover the frame. The side diaphragm and the central diaphragm have protrusions protruding in mutually opposite directions, and a space is formed between the protrusions of the side diaphragm and the protrusions of the central diaphragm.

### PRIORITY CLAIM

The present application claims priority to Korean Patent Application No. 10-2015-0014938 filed on 30 Jan. 2015, the content of said application incorporated herein by reference in its entirety.

### TECHNICAL FIELD

The present invention relates to a receiver, and more particularly, to a receiver having diaphragm including a side diaphragm and a central diaphragm and having a central portion with improved rigidity.

### BACKGROUND

A receiver is a device transferring an audio signal to a user's ear that comes closer thereto, unlike a speaker transferring a sound at a predetermined distance. In general, a receiver is positioned in a receiving part of a mobile phone to generate a telephone sound, or the like.

The receiver is so small that is difficult to manufacture and has a high defect rate, compared with a microspeaker generating sound when DMB of a mobile phone or an MP3 file is played. Also, since the receiver is a subminiature device, a diaphragm thereof is required to be small and thin; however, a thin diaphragm has shortcomings in that rigidity of a central portion thereof is weak.

FIGS. 1 through 3 are views illustrating a conventional receiver.

In the conventional receiver, a magnetic circuit including a yoke 21, an inner magnet 22, an outer ring magnet 23, an inner top plate 24, and an outer ring top plate 25 is installed within a frame 10, and a vibration unit including a voice coil 30 having a lower end positioned in an air gap between the inner magnet 22 and the outer ring magnet 23 and a diaphragm 40, to which the voice coil 30 is attached, vibrating together with the voice coil 30 to generate sound, is mounted on the frame. Also, the related receiver includes a protector engaged with the frame 10 and positioned on the diaphragm 40 to protect the vibration unit and the magnetic circuit.

Referring to FIGS. 2 and 3, the diaphragm 40 provided in the conventional receiver includes an outer circumferential portion 41 mounted on the frame 10, a central portion 43 formed to be spaced apart from the outer circumferential portion 41, and a dome portion 42 elastically connecting the outer circumferential portion 41 and the central portion 43. The dome portion 42 may protrude in an upward direction, that is, in a direction toward the protector 50, or protrude in a downward direction, that is, in a direction toward the yoke 21. In the conventional illustrated in FIGS. 2 and 3, the dome portion 42 has a reversed dome shape protruding in a downward direction. The dome portion 42 includes a plurality of protruding ribs 44 increasing elastic force and rigidity to support the central portion 43. The central portion 43 includes a plurality of protrusions 45 increasing rigidity of the central portion 43 to increase a bandwidth of the receiver. The protrusions 44 may protrude upwardly or downwardly. In the conventional illustrated in FIGS. 2 and 3, an example in which the protrusions 44 protrude upwardly is illustrated.

The conventional receiver illustrated in FIGS. 1 through 3 has the protrusions 45 to increase rigidity of the central portion thereof, but the rigidity is still insufficient and the bandwidth is not wide yet.

### SUMMARY

An object of the present invention is to provide a receiver with rigidity improved to widen a bandwidth, as a subminiature receiver.

According to an aspect of the present invention for achieving the above objects, there is provided a receiver having a diaphragm with improved rigidity, including: a frame; a yoke coupled to the frame and forming a bottom surface; a magnet coupled to the yoke; a voice coil provided such that a lower end thereof is positioned in an air gap of the magnet, and vibrated up and down by mutual electromagnetic force as a current is applied thereto; a side diaphragm allowing the voice coil to be attached to a lower surface thereof; a central diaphragm attached to the center of the side diaphragm; and a protector coupled to the frame to cover the frame, wherein the side diaphragm and the central diaphragm have protrusions protruding in mutually opposite directions, and a space is formed between the protrusions of the side diaphragm and the protrusions of the central diaphragm.

The protrusions formed on the central diaphragm may include a first protrusion formed in a first direction and a second protrusion formed to traverse the first protrusion and protruding further than the first protrusion.

The side diaphragm may include an outer circumferential portion mounted on the frame, a central portion disposed to be spaced apart from the outer circumferential portion by a predetermined interval and allowing the central diaphragm to be attached thereto, and a dome portion protruding upwardly or downwardly to elastically connect the outer circumferential portion and the central portion.

The central diaphragm may be attached to an upper surface of the side diaphragm, and the protrusions of the side diaphragm may protrude downwardly, and the protrusions of the central diaphragm may protrude upwardly.

The central diaphragm may be attached to a lower surface of the side diaphragm, and the protrusions of the side diaphragm may protrude upwardly, and the protrusions of the central diaphragm may protrude downwardly.

In the receiver according to an embodiment of the present invention, since the central diaphragm is additionally attached to the central portion of the side diaphragm, rigidity of the central portion of the diaphragm may be improved.

Also, in the receiver according to an embodiment of the present invention, since the side diaphragm and the central diaphragm have protrusions, separately, rigidity of the central portion of the diaphragm may be further improved.

Also, in the receiver according to an embodiment of the present invention, since a space is formed between the protrusions provided in the side diaphragm and the central diaphragm to form an air layer, rigidity of the central portion of the diaphragm may be further improved.

Those skilled in the art will recognize additional features and advantages upon reading the following detailed description, and upon viewing the accompanying drawings.

### BRIEF DESCRIPTION OF THE DRAWINGS

FIG. 1 is a cross-sectional view of a conventional receiver;

FIG. 2 is a view illustrating a diaphragm provided in the conventional receiver of FIG. 1;

FIG. 3 is a cross-sectional view taken along line A-A in FIG. 2;

FIG. 4 is a cross-sectional view of a receiver in which a central portion of a diaphragm has improved rigidity according to an embodiment of the present invention;

FIG. 5 is a view illustrating a diaphragm of a receiver in which a central portion of a diaphragm has improved rigidity according to an embodiment of the present invention; and

FIG. 6 is a cross-sectional view illustrating a diaphragm of a receiver in which a central portion of a diaphragm has improved rigidity according to an embodiment of the present invention.

### DETAILED DESCRIPTION

Hereinafter, the present invention will be described in detail with reference to the accompanying drawings.

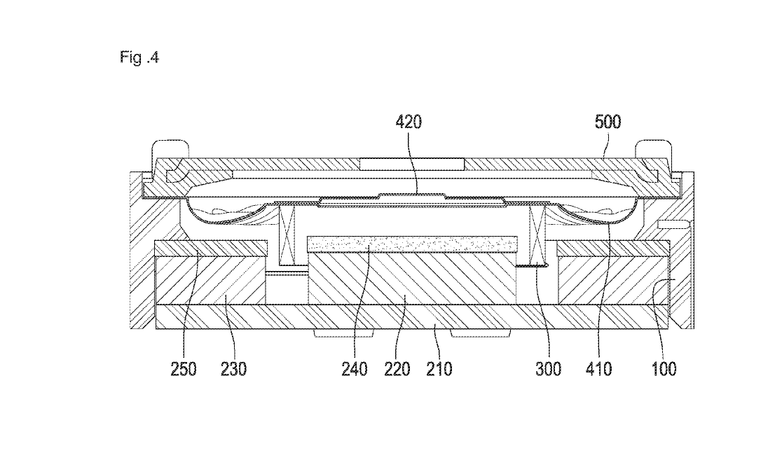

FIG. 4 is a cross-sectional view of a receiver in which a central portion of a diaphragm has improved rigidity according to an embodiment of the present invention.

A receiver in which a central portion of a diaphragm has improved rigidity according to an embodiment of the present invention includes a frame 100, a magnetic circuit unit, a vibration unit, and a protector 500, like the conventional receiver.

The magnetic circuit unit includes a yoke 210 coupled to a bottom of the frame 100 to form a bottom surface of the receiver, an inner magnet 220 attached to the yoke 210 and positioned within the frame, an outer ring magnet 230 attached to the yoke 210, positioned within the frame 100, and positioned to be spaced apart from the inner magnet 220 by a predetermined interval, an inner top plate 240 attached to an upper surface of the inner magnet 220 to assist formation of a magnetic field, and an outer ring top plate 250 attached to an upper surface of the outer ring magnet 230 to assist formation of a magnetic field.

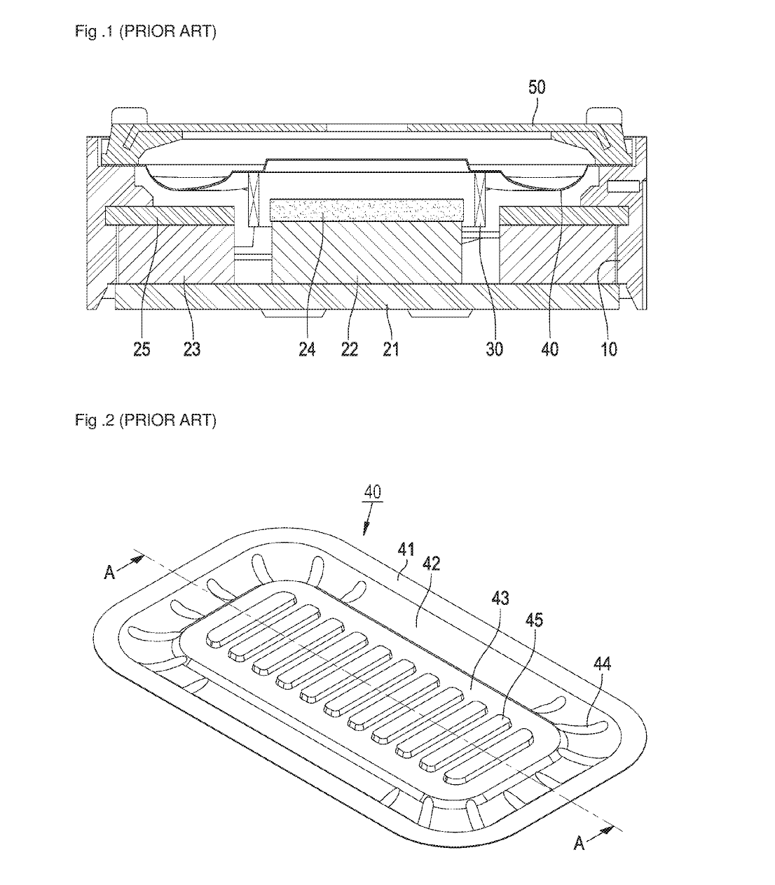

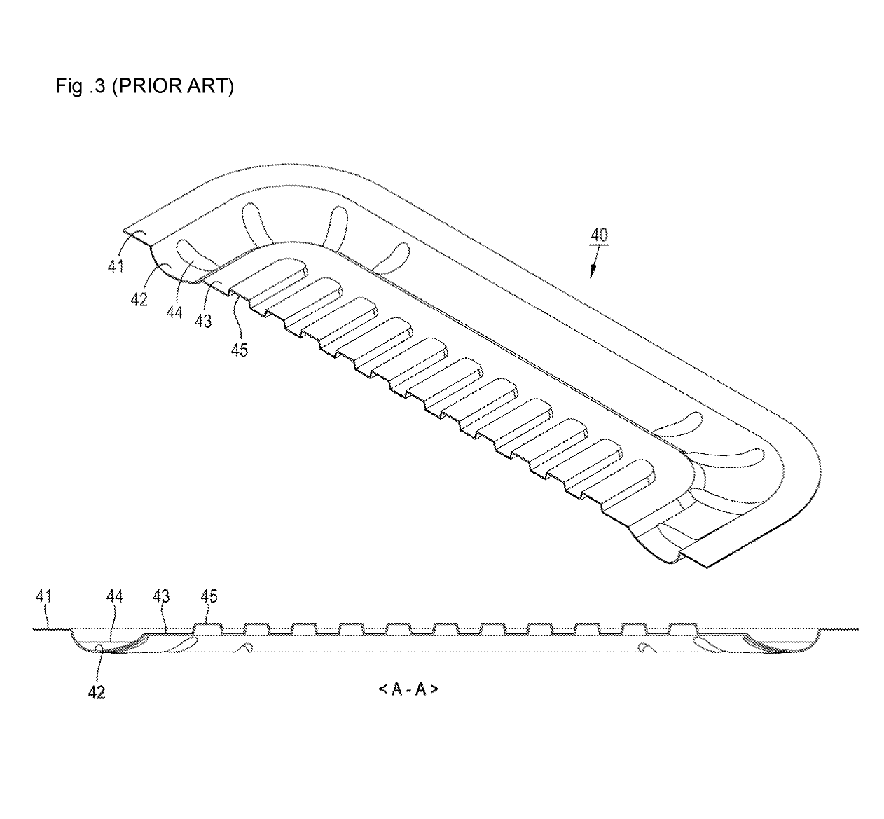

The vibration unit includes a voice coil 300 and a diaphragm, and the diaphragm includes a side diaphragm 410 and a central diaphragm 420. A lower end of the voice coil 300 is positioned in an air gap between the inner magnet 220 and the outer ring magnet 230, and vibrates up and down according to mutual electromagnetic force when a signal is applied to the voice coil 300. An outer circumferential portion 411 (see FIG. 2) of the side diaphragm 410 is mounted on the frame 100, and the voice coil 300 is attached to a lower surface of the side diaphragm 410. Thus, when the voice coil 300 vibrates, the side diaphragm 410 vibrates together to generate sound. The central diaphragm 420 is attached to a central portion 413 (pleases refer to FIG. 2) of the side diaphragm 410 to improve rigidity of the central portion of the diaphragm.

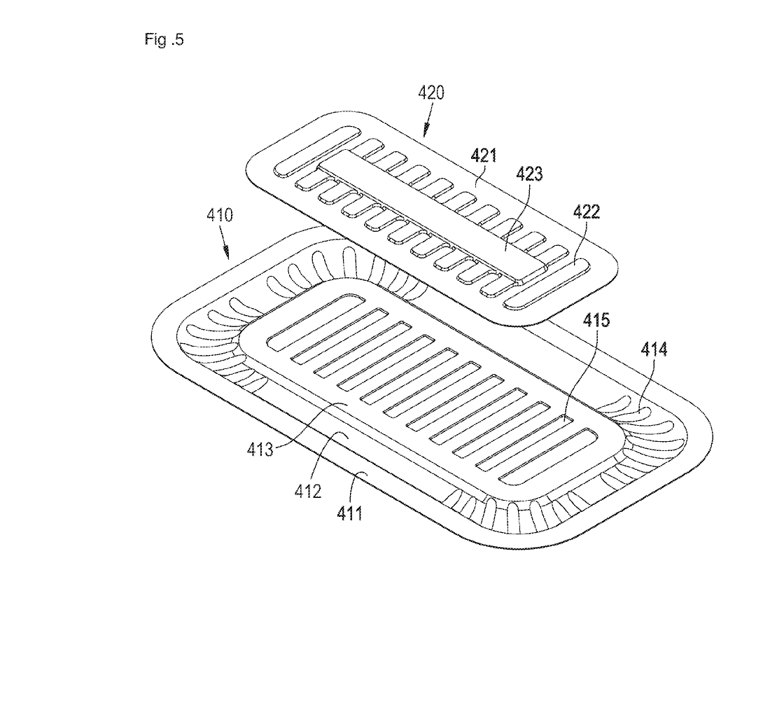

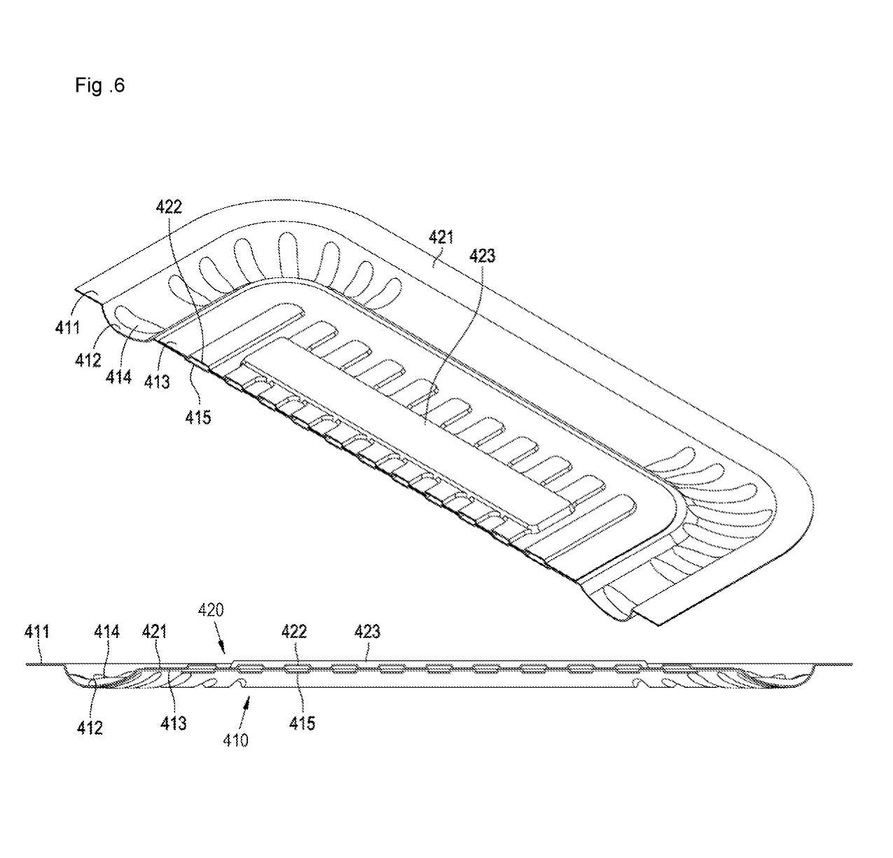

FIG. 5 is a view illustrating a diaphragm of a receiver in which a central portion of a diaphragm has improved rigidity according to an embodiment of the present invention, and FIG. 6 is a cross-sectional view illustrating a diaphragm of a receiver in which a central portion of a diaphragm has improved rigidity according to an embodiment of the present invention.

The side diaphragm 410 includes an outer circumferential portion 411 mounted on the frame 100 (see FIG. 4), a central portion 413 formed to be spaced apart from the outer circumferential portion 411 and allowing the voice coil 300 (see FIG. 4) and the central diaphragm 420 to be attached thereto, and a dome portion 412 protruding downwardly to elastically connect the outer circumferential portion 411 and the central portion 413. In the embodiment illustrated in FIGS. 5 and 6, the dome portion 412 protrudes downwardly, but a dome portion protruding upwardly may also be employed.

The dome portion 412 includes a plurality of protrusion ribs 414 for increasing rigidity of the dome portion 412 so that the central portion 413 may not sag due to weight of the voice coil 300 and the central diaphragm 420 attached thereto. The protrusion ribs 414 are generally formed at the corner portions, but may also be formed in other portions.

The central portion 413 of the side diaphragm 410 has a plurality of protrusions 415 for increasing rigidity of the central portion 413 to widen a range generated by the receiver. A plurality of protrusions 415 are provided to be parallel to a shorter side of the side diaphragm 410 having a rectangular shape. Here, when the side diaphragm 410 has a rectangular shape, it may also include a shape in which the corners of the rectangular shape are rounded or chamfered. The plurality of protrusions 415 may also be disposed to be parallel to a longer side of the side diaphragm 410 or may have any other shape such as a grid shape.

The central diaphragm 420 has an attachment surface 421 attached to the central portion 413 of the side diaphragm 410 and a plurality of first protrusions 422 protruding from the attachment surface 421. The first protrusions 422 and the protrusions 415 of the side diaphragm 410 have shapes corresponding to each other, and protrude in the mutually opposite directions such that a space may be formed therebetween. According to the embodiment illustrated in FIGS. 5 and 6, the central diaphragm 420 is attached to an upper surface of the side diaphragm 410, the protrusions 415 protrude downwardly, and the first protrusions 422 protrude upwardly. However, the central diaphragm 420 may be attached to a lower surface of the side diaphragm 410, the protrusions 415 may protrude upwardly, and the first protrusions 422 may protrude downwardly. In this manner, since a space allowing an air layer to be formed therein is provided by the protrusions 415 and the first protrusions 422, rigidity of the central portion of the diaphragm may be further improved to help increase a bandwidth of the receiver.

The central diaphragm 420 may further include a second protrusion 423, in addition to the first protrusions 422. The second protrusion 423 is provided to traverse the plurality of first protrusions 422, and a protruding height of the second protrusion 423 is higher than that of the first protrusions 422. However, the protruding height of the second protrusion 423 may be equal to or lower than that of the first protrusions 422. Since the second protrusion 423 is additionally formed, rigidity of the central portion of the diaphragm may be further improved.

As used herein, the terms “having”, “containing”, “including”, “comprising” and the like are open-ended terms that indicate the presence of stated elements or features, but do not preclude additional elements or features. The article and “the” are intended to include the plural as well as the singular, unless the context clearly indicates otherwise.

With the above range of variations and applications in mind, it should be understood that the present invention is not limited by the foregoing description, nor is it limited by the accompanying drawings. Instead, the present invention is limited only by the following claims and their legal equivalents.

What is claimed is:

1. A receiver having a diaphragm with improved rigidity, the receiver comprising:
a frame;
a yoke coupled to the frame and forming a bottom surface;
a magnet coupled to the yoke;
a voice coil having a lower end positioned in an air gap of the magnet, the voice coil being configured to vibrate up and down by mutual electromagnetic force as a current is applied to the voice coil;
a side diaphragm configured to allow the voice coil to be attached to a lower surface of the side diaphragm;
a central diaphragm attached to a center of the side diaphragm; and
a protector coupled to the frame to cover the frame,
wherein the side diaphragm and the central diaphragm have protrusions protruding in mutually opposite directions, and a space is formed between the protrusions of the side diaphragm and the protrusions of the central diaphragm.

2. The receiver of claim 1, wherein the protrusions formed on the central diaphragm include a first protrusion formed in a first direction and a second protrusion formed to traverse the first protrusion and protruding further than the first protrusion.

3. The receiver of claim 1, wherein the side diaphragm includes an outer circumferential portion mounted on the frame, a central portion spaced apart from the outer circumferential portion by a predetermined interval and configured to allow the central diaphragm to be attached to the central portion, and a dome portion protruding upwardly or downwardly to elastically connect the outer circumferential portion and the central portion.

4. The receiver of claim 1, wherein the central diaphragm is attached to an upper surface of the side diaphragm, and the protrusions of the side diaphragm protrude downwardly and the protrusions of the central diaphragm protrude upwardly.

5. The receiver of claim 1, wherein the central diaphragm is attached to a lower surface of the side diaphragm, and the protrusions of the side diaphragm protrude upwardly, and the protrusions of the central diaphragm protrude downwardly.
